(19) United States
(12) Patent Application Publication
(10) Pub. No.: US 2024/0336122 A1
(43) Pub. Date: Oct. 10, 2024

(54) DUAL MOTOR EV AXLE SYSTEM AND METHOD

(71) Applicants: High Desert Racing Products, LLC, Reno, NV (US); Hypercraft Inc., Provo, UT (US)

(72) Inventors: Ethan Fickling, Provo, UT (US); Jacob Hawksworth, Provo, UT (US)

(21) Appl. No.: 18/627,171

(22) Filed: Apr. 4, 2024

Related U.S. Application Data
(60) Provisional application No. 63/456,871, filed on Apr. 4, 2023.

(51) Int. Cl. B60K 1/02; B60K 17/04

(52) U.S. Cl. CPC B60K 1/02; B60K 17/043

(57) ABSTRACT

A dual motor electric vehicle (EV) axle system uses electric motors to power two wheels on a vehicle and allows for a high center ground clearance. The dual motor EV axle system includes a rear axle with a center axle section, two electric motors, gear reduction units, and spindles. The gear reduction units are vertically oriented to raise a center section of the axle. The motors are mounted at ends or at a center of an axle tube of the axle.

### CROSS-REFERENCE TO RELATED APPLICATION

This application claims the benefit of U.S. Provisional Patent Application No. 63/456,871, filed Apr. 4, 2023, under 35 U.S.C. 119 and is incorporated herein in its entirety.

### FIELD OF THE INVENTION

The present invention relates drivetrains with high ground clearance.

### BACKGROUND OF THE INVENTION

Drive axles with differentials offer many benefits. However, a problem with drive axles including differentials is the limited ground clearance caused by the differential being mounted in the middle of the axle.

### SUMMARY OF THE INVENTION

An aspect of the present disclosure involves a dual motor electric vehicle (EV) axle system that uses electric motors to power two wheels on a vehicle and allows for a high center ground clearance. The dual motor EV axle system includes a rear axle with a center axle section, two electric motors, gear reduction units, and spindles. The gear reduction units are vertically oriented to raise a center section of the axle. The motors are mounted at ends or at a center of an axle tube of the axle.

Another aspect of the disclosure involves a dual motor electric vehicle axle system comprising an axle including a center section; a pair of electric motors coupled to the axle and configured to power respective wheels of a vehicle; a pair of gear reduction units, the gear reducing units each including an upper end and a lower end; a pair of spindles, wherein the electric motors each coupled to the gear reducing unit adjacent to the upper end of the gear reducing unit and the spindles each coupled to the gear reducing unit adjacent to the lower end of the gear reducing unit so that ground clearance is provided between the center section of the axle and a support surface.

One or more implementations of the aspect of the disclosure described most immediately above includes one or more of the following: the pair of gear reducing units are each elongated in a vertical direction so that ground clearance is provided between the center section of the axle and a support surface; the axle includes opposite ends and the pair of electric motors are coupled to the axle at the opposite ends of the axle; the pair of electric motors are coupled to the axle at the center section; and/or the gear reduction units are portal gear reduction units.

A further aspect of the present disclosure involves a method of using a dual motor electric vehicle axle system comprising providing a dual motor electric vehicle axle system comprising a dual motor electric vehicle axle system comprising an axle including a center section; a pair of electric motors coupled to the axle and configured to power respective wheels of a vehicle; a pair of gear reduction units, the gear reducing units each including an upper end and a lower end; a pair of spindles, wherein the electric motors each coupled to the gear reducing unit adjacent to the upper end of the gear reducing unit and the spindles each coupled to the gear reducing unit adjacent to the lower end of the gear reducing unit so that ground clearance is provided between the center section of the axle and a support surface; transmitting power from the pair of electric motors to the pair of gear reducing units adjacent to the upper ends at substantially a clearance height CH; transmitting power from the pair of gear reducing units to the pair of spindles adjacent to the lower ends at substantially a clearance height CH, which is less than clearance height CH, so that ground clearance is provided between the center section of the axle and the support surface.

One or more implementations of the aspect of the disclosure described most immediately above includes one or more of the following: the pair of gear reducing units are each elongated in a vertical direction so that ground clearance is provided between the center section of the axle and a support surface; the axle includes opposite ends and the pair of electric motors are coupled to the axle at the opposite ends of the axle; the pair of electric motors are coupled to the axle at the center section; and/or the gear reduction units are portal gear reduction units.

### BRIEF DESCRIPTION OF DRAWINGS

The accompanying drawings, which are incorporated in and form a part of this specification illustrate embodiments of the invention and together with the description, serve to explain the principles of the invention.

FIG. 1 is simplified cross-sectional view of a dual motor EV axle system.

FIG. 2 is flow chart of an exemplary method of using the dual motor EV axle system.

### DESCRIPTION OF EMBODIMENT OF THE INVENTION

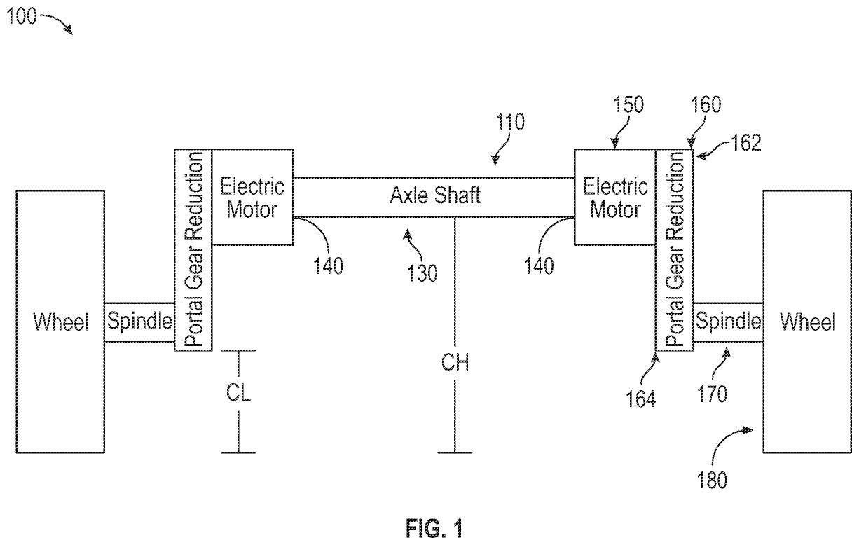

With reference to FIG. 1, an embodiment of a dual motor electric vehicle (EV) axle system 100 will be described.

The dual motor EV system 100 includes an elevated axle or axle shaft (e.g., rear axle) 110 with a center section 130 and opposite ends 140, a pair of electric motors 150 mounted at the opposite ends 140 (or, alternatively, in the center section 130) of the axle 110, vertically oriented (elongated in a vertical orientation/direction) gear reduction units (e.g., portal gear reduction(s)) 160 having upper ends 162 and lower ends 164, and spindles 170.

The dual motor EV system 100 uses the electric motors 150 to power two wheels 180 on a vehicle and the vertically oriented elongated gear reduction units 160 raise the center section 130 of the axle 110 to allow for a higher center ground clearance CH compared to a lower, limited ground clearance CL caused by the differential being mounted in the middle of the axle in the past.

In the dual motor EV system 100, the differential is eliminated due to the motors 150 being electric and mounted to the axle 110. The gear reduction units 160, being vertically mounted (elongated in a vertical orientation/direction), allow the center section 130 to be significantly raised.

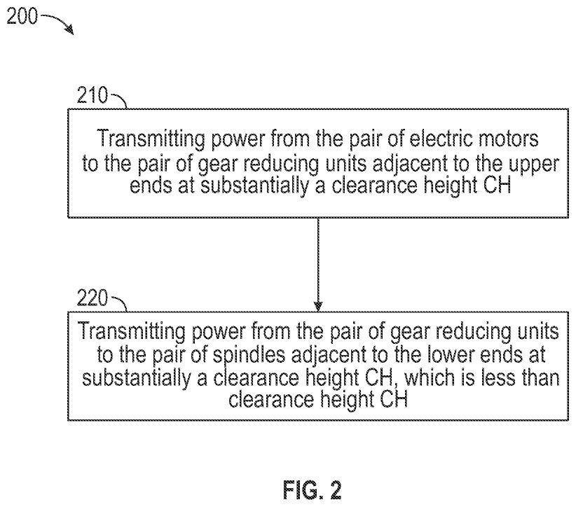

With reference to FIG. 2, a method 200 of using a dual motor electric vehicle axle system 100 comprises, at step 210, transmitting power from the pair of electric motors 150 to the pair of gear reducing units 160 adjacent to the upper ends 162 at substantially the clearance height CH; and, at step 220, transmitting power from the pair of gear reducing units 160 to the pair of spindles 170 adjacent to the lower ends 164 at substantially the clearance height CH, which is less than clearance height CH, so that ground clearance is provided between the center section 130 of the axle 110 and the support surface.

The above figures may depict exemplary configurations for the invention, which is done to aid in understanding the features and functionality that can be included in the invention. The invention is not restricted to the illustrated architectures or configurations, but can be implemented using a variety of alternative architectures and configurations. Additionally, although the invention is described above in terms of various exemplary embodiments and implementations, it should be understood that the various features and functionality described in one or more of the individual embodiments with which they are described, but instead can be applied, alone or in some combination, to one or more of the other embodiments of the invention, whether or not such embodiments are described and whether or not such features are presented as being a part of a described embodiment. Thus the breadth and scope of the present invention, especially in the following claims, should not be limited by any of the above-described exemplary embodiments.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

I/We claim:

1. A dual motor electric vehicle axle system, comprising:
an axle including a center section;
a pair of electric motors coupled to the axle and configured to power respective wheels of a vehicle;
a pair of gear reduction units, the gear reducing units each including an upper end and a lower end;
a pair of spindles,
wherein the electric motors each coupled to the gear reducing unit adjacent to the upper end of the gear reducing unit and the spindles each coupled to the gear reducing unit adjacent to the lower end of the gear reducing unit so that ground clearance is provided between the center section of the axle and a support surface.

2. The dual motor electric vehicle axle system of claim 1, wherein the pair of gear reducing units are each elongated in a vertical direction so that ground clearance is provided between the center section of the axle and a support surface.

3. The dual motor electric vehicle axle system of claim 1, wherein the axle includes opposite ends and the pair of electric motors are coupled to the axle at the opposite ends of the axle.

4. The dual motor electric vehicle axle system of claim 1, wherein the pair of electric motors are coupled to the axle at the center section.

5. The dual motor electric vehicle axle system of claim 1, wherein the gear reduction units are portal gear reduction units.

6. A method of using a dual motor electric vehicle axle system, comprising:
providing the dual motor electric vehicle axle system of claim 1;
transmitting power from the pair of electric motors to the pair of gear reducing units adjacent to the upper ends at substantially a clearance height CH;
transmitting power from the pair of gear reducing units to the pair of spindles adjacent to the lower ends at substantially a clearance height CH, which is less than clearance height CH, so that ground clearance is provided between the center section of the axle and the support surface.

7. The method of claim 6, wherein the pair of gear reducing units are each elongated in a vertical direction so that ground clearance is provided between the center section of the axle and a support surface.

8. The method of claim 6, wherein the axle includes opposite ends and the pair of electric motors are coupled to the axle at the opposite ends of the axle.

9. The method of claim 6, wherein the pair of electric motors are coupled to the axle at the center section.

10. The method of claim 6, wherein the gear reduction units are portal gear reduction units.
